(19) United States
(12) Patent Application Publication
(10) Pub. No.: US 2014/0372046 A1
(43) Pub. Date: Dec. 18, 2014

(54) APPARATUS AND METHOD FOR MANAGING GENETIC INFORMATION

(71) Applicants: MACROGEN INC., Seoul (KR); SNU R&DB FOUNDATION, Seoul (KR)

(72) Inventors: Hedoo Chung, Seoul (KR); Jeong-Sun Seo, Seoul (KR); Hwanseok Rhee, Seoul (KR)

(73) Assignee: MACROGEN INC., Seoul (KR)

(21) Appl. No.: 14/359,977

(22) PCT Filed: Dec. 26, 2012
(86) PCT No.: PCT/KR2012/011477

§ 371 Date: May 22, 2014

(30) Foreign Application Priority Data
Dec. 27, 2011 (KR) 10-2011-0143958

(51) Int. Cl. G06F 19/28

(52) U.S. Cl. CPC G06F 19/28
USPC 702/20

(57) ABSTRACT

A genetic information managing apparatus compares a base sequence of a subject with a standard base sequence to determine a longest common base sequence, and arranges the base sequence of the subject on the standard base sequence in accordance with the longest common base sequence. The genetic information managing apparatus divides the arranged base sequence into a plurality of base code groups, allocates a plurality of identifiers to the plurality of base code groups, respectively, and stores the plurality of base code groups to a plurality of storing units in association with corresponding identifiers.

### TECHNICAL FIELD

The present invention generally relates to an apparatus and a method for managing genetic information.

### BACKGROUND ART

Human genetic information is stored to a base sequence of about three billion bases composed of Adenine, Guanine, Cytosine, and Thymine. A technique for decoding an entire base sequence of a subject is commercially available. However, genes whose meanings are interpreted are only part of about thirty thousand genes encrypted by the base sequences.

Because genetic information encrypted by the base sequence is continuously interpreted, the subject having the decoded base sequence will repeatedly check his or her base sequence in order to determine whether or not to have base sequence of the newly interpreted gene.

However, because the genetic information of a certain person indicates genetic characteristic of the family as well as his or her genetic characteristic, an infringement such as hacking to the genetic information can cause serious damages to him or her and the family.

An information technology that extends to a mobile communication service, a financial service, and a medical service creates various technologies such as an encryption technology for protecting the security of the personal information from being infringed. However, the genetic information requires a more powerful protecting technology for the security than other personal information.

### DISCLOSURE OF INVENTION

### Technical Problem

Aspects of the present invention provide a genetic information managing apparatus and method for securely storing and searching for human genetic information

### Solution to Problem

According to an aspect of the present invention, a genetic information managing apparatus including a base sequence receiver, a base code group divider, an identifier allocator, a plurality of storing units, and a storing controller is provided. The base sequence receiver receives a decoded base sequence of a subject, and the base code group divider divides the base sequence into a plurality of base code groups. The identifier allocator allocates a plurality of identifiers to the plurality of base code groups, respectively, and the storing controller stores the plurality of base code groups to the plurality of storing units respectively, in association with corresponding identifiers.

According to another aspect of the present invention, a method of managing genetic information of a subject by a genetic information managing apparatus is provided. The method includes receiving a decoded base sequence of the subject, dividing the base sequence into a plurality of base code groups, allocating a plurality of identifiers to the plurality of base code groups, respectively, and storing the plurality of base code groups to the plurality of storing units respectively, in association with corresponding identifiers.

According to yet another aspect of the present invention, genetic information managing apparatus including an identifier receiver, a plurality of storing units, a base code group collector, a base sequence assembler, an inquiry base sequence receiver, an comparator, and an output unit is provided. The identifier receiver receives identification information of a subject, and the identification information includes a plurality of identifiers. The plurality of storing units store a plurality of base code groups in association with a plurality of identifiers, and the plurality of base code groups are formed by dividing a base sequence. The base code group collector collects a plurality of base code groups that correspond to the plurality of identifiers of the identification information, respectively. The base sequence assembler assembles the collected base code groups in accordance with a rule used for dividing the base sequence to generate a base sequence of a subject. The inquiry base sequence receiver receives an inquiry base sequence. The comparator compares the base sequence of the subject with the inquiry base sequence to determine whether the base sequence of the subject includes the inquiry base sequence, and the output unit outputs information about whether the base sequence of the subject includes the inquiry base sequence.

According to yet another aspect of the present invention, a method of managing genetic information of a subject by a genetic information managing apparatus is provided. The method includes receiving identification information of the subject including a plurality of identifiers, searching for a base code group corresponding to each identifier in a plurality of storing units and collecting a plurality of base code groups that correspond to the plurality of identifiers, respectively, assembling the plurality of base code groups in accordance with a rule used for dividing a base sequence to generate a base sequence of the subject, receiving an inquiry base sequence, comparing the base sequence of the subject with the inquiry base sequence to determine whether the base sequence of the subject includes the inquiry base sequence, and outputting information about whether the base sequence of the subject includes the inquiry base sequence.

### Advantageous Effects of Invention

According to an embodiment of the present invention, if identification information for a plurality of base code groups of a subject is exactly identified, a base sequence of a subject can be exactly restored and searched. However, when the identification information for the base code groups of the subject is not exactly identified, the base sequence of the subject cannot be identified.

Further, when the subject wants to discard his or her own genetic information, the subject just needs to destroy identification information on a plurality of base code groups. Destroying the identification information can produce the same effect as deleting the genetic information in the database.

### BRIEF DESCRIPTION OF DRAWINGS

FIG. 1 is a block diagram of a genetic information managing apparatus according to an embodiment of the present invention.

FIG. 2 is a flowchart of a method for storing genetic information according to an embodiment of the present invention.

FIG. 3 is a flowchart of a method for searching for genetic information according to an embodiment of the present invention.

FIG. 4 shows arrangement and division of a base sequence, and allocation and store of identifiers according to an embodiment of the present invention.

### MODE FOR THE INVENTION

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Now, a genetic information managing apparatus and method according to an embodiment of the present invention is described with reference to the drawings.

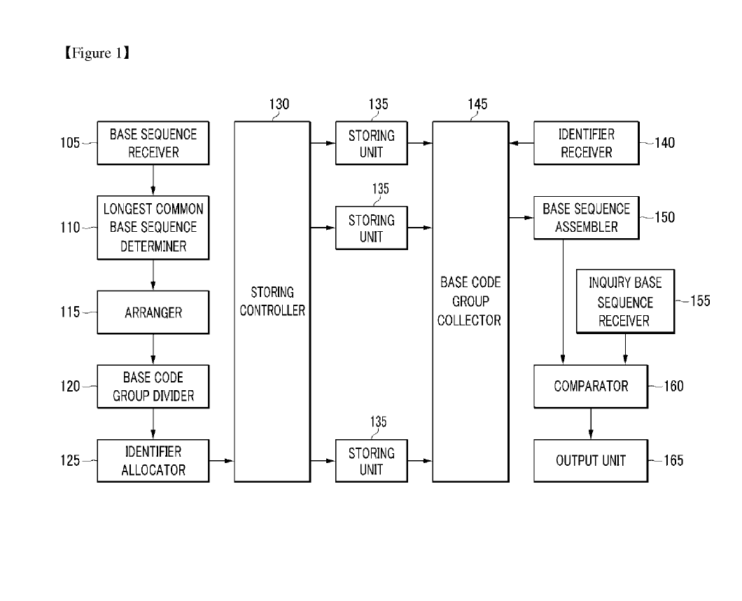

FIG. 1 is a block diagram of a genetic information managing apparatus according to an embodiment of the present invention.

Referring to FIG. 1, a genetic information managing apparatus according to an embodiment of the present invention includes a base sequence receiver 105, a longest common base sequence determiner 110, an arranger 115, a base code group divider 120, an identifier allocator 125, a storing controller 130, a plurality of storing units 135, an identifier receiver 140, a base code group collector 145, a base sequence assembler 150, an inquiry base sequence receiver 155, a comparator 160, and an output unit 165.

The base sequence receiver 105 receives a decoded base sequence of a subject.

The longest common base sequence determiner 110 compares the received base sequence with a standard base sequence and determines a longest common base sequence that corresponds to a longest interval from among common base sequence intervals.

The arranger 115 arranges the base sequence of the subject on the standard base sequence in accordance with the longest common base sequence that is determined by the longest common base sequence determiner 110.

The base code group divider 120 divides the base sequence arranged by the arranger 115 into a plurality of base code groups in accordance with a particular rule. The particular rule may correspond to a plurality of progressions.

The identifier allocator 125 allocates a plurality of identifiers to the base code groups that are divided by the base code group divider 120.

The storing controller 130 stores the base code groups to the storing units 135, respectively.

The storing units 135 may be physically or logically separated.

The identifier receiver 140 receives identification information composed of a plurality of identifiers through an input device from the subject.

The base code group collector 145 searches for a base code group corresponding to each identifier in the storing unit 135 corresponding to each identifier, and collects a plurality of base code groups that correspond to the identifiers, respectively.

The base sequence assembler 150 assembles the base code groups collected by the base code group collector 145 in accordance with the particular rule used for dividing the base sequence, and generates a base sequence of the subject corresponding to the identification information.

The inquiry base sequence receiver 155 receives an inquiry base sequence through the input device from the subject.

The comparator 160 compares the base sequence assembled by the base sequence assembler 150 with the inquiry base sequence received by the inquiry base sequence receiver 155, and determines whether the assembled base sequence includes the inquiry base sequence.

The output unit 165 outputs a comparison result of the comparator 160, and deletes the assembled base sequence in a memory.

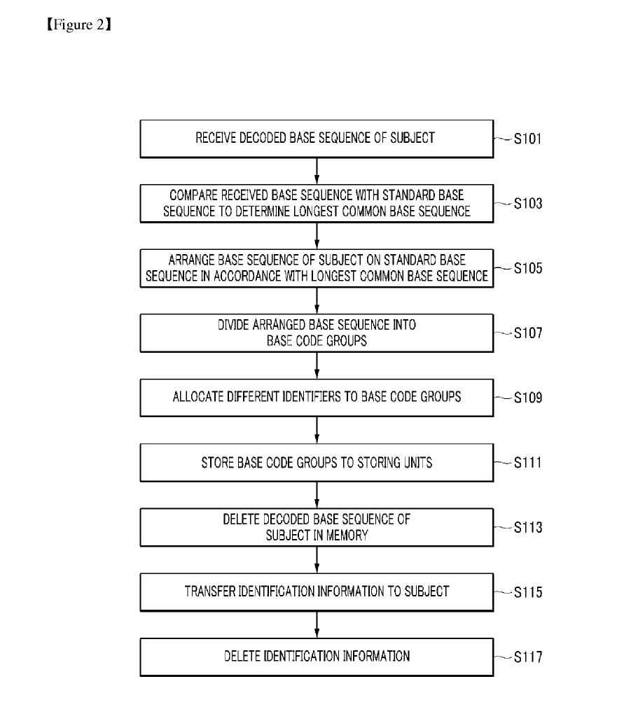

Next, a method for storing genetic information according to an embodiment of the present invention is described with reference to FIG. 2.

FIG. 2 is a flowchart of a method for storing genetic information according to an embodiment of the present invention.

Referring to FIG. 2, a base sequence receiver 105 receives a decoded base sequence of a subject (S101).

A longest common base sequence determiner 110 compares the received base sequence with a standard base sequence to determine a longest common base sequence that corresponds to a longest interval from among common base sequence intervals (S103). For example, when the base sequence of the subject 4 is “. . . AAGCATCC . . . ” and the standard base sequence is “. . . ATGCATGC . . . ”, the longest common base sequence is “GCAT”.

An arranger 115 arranges the base sequence of the subject on the standard base sequence in accordance with the determined longest common base sequence (S105).

A base code group divider 120 divides the arranged base sequence into a plurality of base code groups in accordance with a particular rule (S107). The base code group divider 120 may extract the base code groups that correspond to a plurality of progressions respectively from the arranged base sequence. For example, when the base code group divider 120 generates two base code groups, the base code group divider 120 may extract one base code group corresponding to a progression 2n and another base code group corresponding to a progression 2n−1 from the base sequence, where n is a natural number. In other words, when the base sequence of the subject is “. . . AAGCATCC . . . ”, the base code group divider 120 may generate the base code group “. . . XAXCXTXC . . . ” corresponding to the progression 2n and the base code group “. . . AXGXAXCX . . . ” corresponding to the progression 2n−1. While it has been exemplified that the two base code groups are generated from the base sequence by using the progression 2n for extracting odd numbered elements and the progression 2n−1 for extracting even numbered elements, a plurality of progressions used by the base code group divider 120 may or may not have a duplicated element. Further, the base code group divider 120 may use more complicated progressions to divide more base code groups, thereby improving the security for the genetic information.

The identifier allocator 125 allocates different identifiers to the base code groups (S109). The identifier is used for a password or certification information for inquiring the genetic information. For example, the identifier allocator 125 may allocate an identifier 5 to the base code group “. . . XAXCXTXC . . . ” corresponding to the progression 2n and an identifier 8 to the base code group “. . . AXGXAXCX . . . ” corresponding to the progression 2n−1. The identifier allocator 125 may generate a plurality of identifiers by using a table of random numbers or a random number generator, and allocate the identifiers to the base code groups.

The storing controller 130 stores the base code groups to the storing units 135, respectively (S111). The storing controller 130 may store each base code group to a corresponding storing unit 135 in association with a corresponding identifier. The storing unit 135 may be configured as a plurality of storing units that may be physically or logically divided. In this case, the storing controller 130 may store the base code group “. . . XAXCXTXC . . . ” corresponding to the progression 2n to a storing unit, which corresponds to the progression 2n from among the storing units 135, in association with the identifier 5. Further, the storing controller 130 may store the base code group “. . . AXGXAXCX . . . ” corresponding to the progression 2n−1 to a storing unit, which corresponds to the progression 2n−1 from among the storing units 135, in association with the identifier 8.

After the base code groups are stored, the base sequence receiver 105 deletes the decoded base sequence of the subject in a memory (S113).

The identifier allocator 125 transfers identification information through an output device to the subject (S115).

On receiving an acknowledge message for the identification information through the input device from the subject, the identifier allocator 125 deletes the identification information in the memory (S117). As such, because the identifier allocator 125 deletes the identification information, the genetic information managing apparatus no longer has information about mappings between identifiers and subjects. Instead, the base code groups are stored to the storing units 135 in association with the identifiers.

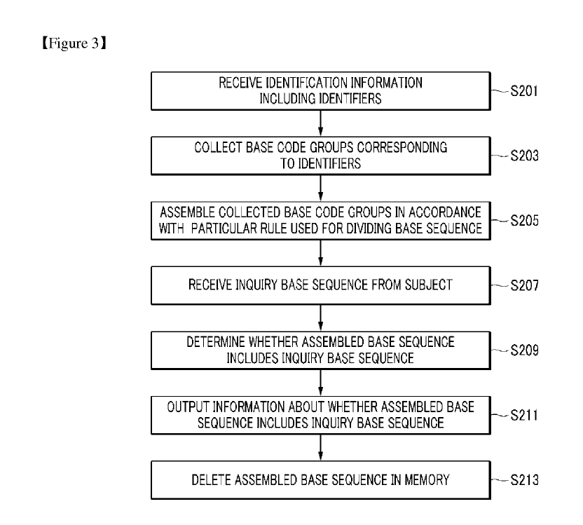

Next, a method for searching for genetic information according to an embodiment of the present invention is described with reference to FIG. 3.

FIG. 3 is a flowchart of a method for searching for genetic information according to an embodiment of the present invention.

Referring to FIG. 3, an identifier receiver 140 receives identification information including a plurality of identifiers through an input device from a subject (S201).

The base code group collector 145 searches for a base code group corresponding to each identifier in the storing unit 135 corresponding to each identifier, and collects a plurality of base code groups corresponding to the identifiers (S203).

The base sequence assembler 150 assembles the collected base code groups in accordance with a particular rule used for dividing the base sequence to generate a base sequence of the subject corresponding to the identification information (S205). The base sequence assembler 150 may assemble the base code groups in accordance with a plurality of progressions used for dividing the base sequence.

An inquiry base sequence receiver 155 receives an inquiry base sequence through the input device from the subject (S207). The inquiry base sequence is a base sequence for specific genetic information, and may be, for example, a base sequence for genetic information that can cause a specific disease.

A comparator 160 compares the base sequence assembled by the base sequence assembler 150 with the inquiry base sequence received by the inquiry base sequence receiver 155 to determine whether the assembled base sequence includes the inquiry base sequence (S209).

The output unit 165 outputs information about whether the assembled base sequence includes the inquiry base sequence (S211), and then deletes the assembled base sequence in the memory (S213).

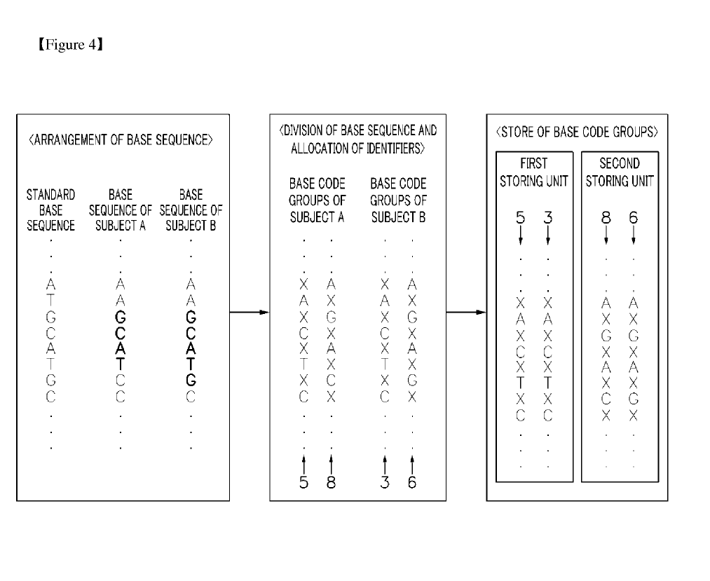

FIG. 4 shows arrangement and division of a base sequence, and allocation and store of identifiers according to an embodiment of the present invention.

A base sequence “. . . AAGCATCC . . . ” of a subject A and a base sequence “. . . AAGCATGC . . . ” of a subject B are exemplified in FIG. 4. Further, it is assumed that a standard base sequence is “. . . ATGCATGC . . . ” and two identifiers are used for securely storing a base sequence of a subject.

In this case, a longest common base sequence for the base sequence of the subject A is “GCAT”, and the base sequence of the subject A is arranged in accordance with the longest common base sequence “GCAT”.

Next, the base sequence “. . . AAGCATCC . . . ” of the subject A is divided into a base code group “. . . XAXCXTXC . . . ” corresponding to a progression 2n and a base code group “. . . AXGXAXCX . . . ” corresponding to a progression 2n−1. Identifiers 5 and 8 are allocated to the two base code groups, respectively.

The base code group “. . . XAXCXTXC . . . ” corresponding to the progression 2n is stored to a first storing unit in association with the identifier 5, and the base code group “. . . AXGXAXCX . . . ” corresponding to the progression 2n−1 is stored to a second storing unit in association with the identifier 8.

Further, a longest common base sequence for the base sequence of the subject B is “GCATG”, and the base sequence of the subject B is arranged in accordance with the longest common base sequence “GCATG”.

Next, the base sequence “. . . AAGCATGC . . . ” of the subject B is divided into a base code group “. . . XAXCXTXC . . . ” corresponding to the progression 2n and a base code group “. . . AXGXAXGX . . . ” corresponding to the progression 2n−1. Identifiers 3 and 6 are allocated to the two base code groups, respectively.

The base code group “. . . XAXCXTXC . . . ” corresponding to the progression 2n is stored to the first storing unit in association with the identifier 5, and the base code group “. . . AXGXAXGX . . . ” corresponding to the progression 2n−1 is stored to the second storing unit in association with the identifier 8.

Therefore, when an identifier receiver 140 receives identification information corresponding to the identifiers 5 and 8 from the subject A, a base code group collector 145 can collect the base code group corresponding to the identifier 5 and the base code group corresponding to the identifier 8 from the storing units 135. A base sequence assembler 150 assembles the two base code groups according to a particular rule used for dividing the base sequence, i.e., the progressions 2n and 2n−1, to generate the base sequence of the subject A. A comparator 160 can compare the base sequence of the subject A, which is assembled by the base sequence assembler 150, with the inquiry base sequence receiver which is received by the inquiry base sequence receiver 155 to determine whether the base sequence of the subject A includes the inquiry base sequence.

As described above, according to an embodiment of the present invention, if identification information for a plurality of base code groups of a subject is exactly identified, entire base sequence of the subject can be restored and searched. However, when the identification information for the base code groups of the subject is not exactly identified, the base sequence of the subject cannot be identified even if information on the entire base sequence that is stored in a database is leaked by a hacking. In other words, the base sequence of the subject cannot be identified because all combinations of base code groups correspond to base sequences that can be biologically existed.

Further, when the subject wants to discard his or her own genetic information, the subject just needs to destroy identification information on a plurality of base code groups. In other words, because destroying the identification information can produce the same effect as deleting the genetic information in the database, powerful protecting technology for the security can be provided.

An apparatus and a method for managing genetic information according to an embodiment of the present invention can be combined with a general encryption scheme. Further, an embodiment of the present invention is not embodied only by an apparatus and/or method. Alternatively, the embodiment may be embodied by a program performing functions that correspond to the configuration of the embodiments of the present invention, or a recording medium on which the program is recorded.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

1. An apparatus for managing genetic information, comprising:
a base sequence receiver configured to receive a decoded base sequence of a subject;
a base code group divider configured to divide the base sequence into a plurality of base code groups;
an identifier allocator configured to allocate a plurality of identifiers to the plurality of base code groups, respectively;
a plurality of storing units; and
a storing controller configured to store the plurality of base code groups to the plurality of storing units respectively, in association with corresponding identifiers.

2. The apparatus of claim 1, further comprising:
a longest common base sequence determiner configured to determine a longest common base sequence that corresponds to common base sequence intervals between the base sequence and a standard base sequence; and
an arranger configured to arrange the base sequence on the standard base sequence in accordance with the longest common base sequence,
wherein the base code group divider divides the arranged base sequence into the plurality of base code groups.

3. The apparatus of claim 2, wherein the longest common base sequence corresponds to a longest interval from among the common base sequence intervals.

4. The apparatus of claim 2, wherein the base code group divider extracts the plurality of base code groups that correspond to a plurality of progressions respectively from the arranged base sequence.

5. The apparatus of claim 4, wherein the plurality of progressions have a duplicated element.

6. The apparatus of claim 4, wherein the plurality of progressions have no duplicated element.

7. The apparatus of claim 1, wherein the identifier allocator generates the plurality of identifiers by generating random numbers, and allocates the plurality of identifiers to the plurality of base code groups, respectively.

8. The apparatus of claim 1, wherein the base sequence receiver deletes the base sequence of the subject a memory after storing the plurality of base code groups to the plurality of storing units, and
wherein the identifier allocator deletes the plurality of identifiers in a memory after transferring identification information corresponding to the plurality of identifiers to the subject.

9. A method of managing genetic information of a subject by a genetic information managing apparatus, the method comprising:
receiving a decoded base sequence of the subject;
dividing the base sequence into a plurality of base code groups;
allocating a plurality of identifiers to the plurality of base code groups, respectively; and
storing the plurality of base code groups to the plurality of storing units respectively, in association with corresponding identifiers.

10. The method of claim 9, further comprising:
determining a longest common base sequence that corresponds to common base sequence intervals between the base sequence and a standard base sequence; and
arranging the base sequence on the standard base sequence in accordance with the longest common base sequence,
wherein dividing the base sequence includes dividing the arranged base sequence into the plurality of base code groups.

11. The method of claim 9, wherein dividing the arranged base sequence includes extracting the plurality of base code groups that correspond to a plurality of progressions respectively from the arranged base sequence.

12. An apparatus for managing genetic information, comprising:
an identifier receiver configured to receive identification information of a subject, the identification information including a plurality of identifiers;
a plurality of storing units configured to store a plurality of base code groups in association with a plurality of identifiers, the plurality of base code groups being formed by dividing a base sequence;
a base code group collector configured to collect a plurality of base code groups that correspond to the plurality of identifiers of the identification information, respectively;
a base sequence assembler configured to assemble the collected base code groups in accordance with a rule used for dividing the base sequence to generate a base sequence of a subject;
an inquiry base sequence receiver configured to receive an inquiry base sequence;
an comparator configured to compare the base sequence of the subject with the inquiry base sequence to determine whether the base sequence of the subject includes the inquiry base sequence; and
an output unit configured to output information about whether the base sequence of the subject includes the inquiry base sequence.

13. The apparatus of claim 12, wherein a certain base sequence is divided into a plurality of base code groups in accordance with a plurality of progressions, and
wherein the rule corresponds to the plurality of progressions.

14. The apparatus of claim 12, wherein the output unit deletes the base sequence of the subject in a memory after outputting the information about whether the base sequence of the subject includes the inquiry base sequence.

15. A method of managing genetic information of a subject by a genetic information managing apparatus, the method comprising:
receiving identification information of the subject, the identification information including a plurality of identifiers;
searching for a base code group corresponding to each identifier in a plurality of storing units and collecting a plurality of base code groups that correspond to the plurality of identifiers, respectively;
assembling the plurality of base code groups in accordance with a rule used for dividing a base sequence to generate a base sequence of the subject;
receiving an inquiry base sequence;
comparing the base sequence of the subject with the inquiry base sequence to determine whether the base sequence of the subject includes the inquiry base sequence; and
outputting information about whether the base sequence of the subject includes the inquiry base sequence.

16. The method of claim 15, wherein a certain base sequence is divided into a plurality of base code groups in accordance with a plurality of progressions, and
wherein the rule corresponds to the plurality of progressions.
